(19) United States
(12) Patent Application Publication
(10) Pub. No.: US 2020/0242144 A1
(43) Pub. Date: Jul. 30, 2020

(54) DISPLAY CONTROL SYSTEM AND STORAGE MEDIUM

(71) Applicant: Kabushiki Kaisha Toshiba, Tokyo (JP)

(72) Inventors: Takami Yoshida, Kamakura Kanagawa (JP); Nayuko Watanabe, Kawasaki Kanagawa (JP); Hiroshi Fujimura, Yokohama Kanagawa (JP); Kenji Iwata, Machida Tokyo (JP); Yuka Kobayashi, Seto Aichi (JP)

(21) Appl. No.: 16/565,091

(22) Filed: Sep. 9, 2019

(30) Foreign Application Priority Data
Jan. 30, 2019 (JP) 2019-014418

(51) Int. Cl. G06F 16/332; G06F 3/14; G06F 17/27; G06F 16/338; G06F 16/33

(52) U.S. Cl. CPC G06F 16/3329; G06F 3/14; G06F 16/3344; G06F 16/338; G06F 17/2755

(57) ABSTRACT

According to one embodiment, a display control system includes a processor. The processor is capable of displaying a second sentence and at least a part of a first question-answer pair when accepting a first sentence including a first query keyword. The first sentence is input by a user. The first question-answer pair includes a first question and a first answer to the first question. The first question includes the first query keyword. The second sentence includes a first question keyword included in the first question. The processor is capable of displaying a word other than the first query keyword and the first question keyword in a first form, the first query keyword in a second form different from the first form, and the first question keyword in a third form different from the first form and the second form.

### CROSS-REFERENCE TO RELATED APPLICATIONS

This application is based upon and claims the benefit of priority from Japanese Patent Application No. 2019-014418, filed on Jan. 30, 2019; the entire contents of which are incorporated herein by reference.

### FIELD

Embodiments described herein relate generally to a display control system and a storage medium.

### BACKGROUND

A system uses a dialog with a user to output an answer to an inquiry from the user. It is desirable to develop technology of such a system so that the user easily can estimate what kind of sentence to input to the dialog system to easily obtain the sought question-answer pair.

### BRIEF DESCRIPTION OF THE DRAWINGS

FIG. 1 is a schematic view illustrating a display control system according to a first embodiment;

FIG. 2 is a table illustrating a question-answer table;

FIG. 3 is a flowchart illustrating the processing of the display control system according to the first embodiment;

FIG. 4 to FIG. 6 are schematic views illustrating outputs of the display control system according to the first embodiment;

FIG. 7 is a schematic view illustrating a display control system according to a second embodiment;

FIG. 8 is a flowchart illustrating the processing of the display control system according to the second embodiment;

FIG. 9 and FIG. 10 are schematic views illustrating outputs of the display control system according to the second embodiment;

FIG. 11 is a schematic view illustrating a display control system according to a modification of the second embodiment;

FIG. 12 and FIG. 13 are schematic views illustrating the outputs of the display control system according to the modification of the second embodiment;

FIG. 14 is a schematic view illustrating a display control system according to a third embodiment;

FIG. 15 is a flowchart illustrating the processing of the display control system according to the third embodiment;

FIG. 16 and FIG. 17 are schematic views illustrating outputs of the display control system according to the third embodiment; and

FIG. 18 is a schematic view illustrating the configuration of a dialog device according to the embodiment.

### DETAILED DESCRIPTION

According to one embodiment, a display control system includes a processor. The processor is capable of displaying a second sentence and at least a part of a first question-answer pair when accepting a first sentence including a first query keyword. The first sentence is input by a user. The first question-answer pair includes a first question and a first answer to the first question. The first question includes the first query keyword. The second sentence includes a first question keyword included in the first question. The processor is capable of displaying a word other than the first query keyword and the first question keyword in a first form, the first query keyword in a second form different from the first form, and the first question keyword in a third form different from the first form and the second form.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

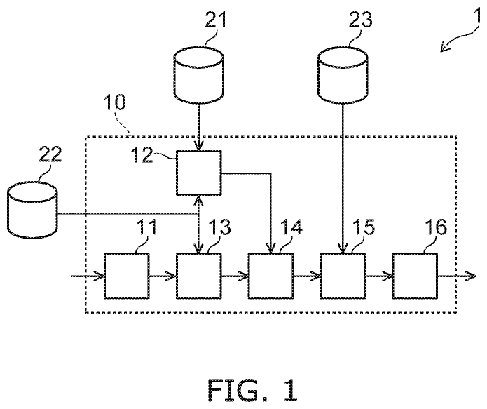

FIG. 1 is a schematic view illustrating a display control system according to a first embodiment.

The display control system 1 according to the first embodiment includes a processor 10. In the example shown in FIG. 1, the display control system 1 further includes a first memory 21, a second memory 22, and a third memory 23.

The processor 10 accepts a sentence input from the user. The processor 10 outputs a response to the input sentence. The response that is output is displayed in an external display device (e.g., a monitor). Based on the response from the processor 10, the user inputs the next sentence to the processor 10. The processor 10 outputs the response to the next sentence based on the dialog with the user up to that point. Thereby, the dialog is realized between the user and the display control system 1.

The first memory 21 stores a question-answer table. The question-answer table includes multiple question-answer pairs. The question-answer pairs each include a question, and an answer to the question. The second memory 22 stores a keyword list, rules, or a model for extracting keywords from the sentence. For example, the third memory 23 stores generic scenarios for generating the response output from the processor 10. The processor 10 generates the response to the input sentence while referring to the first to third memories 21 to 23.

For example, the sentence that is input from the user includes an inquiry. Here, the sentence that is input from the user to the processor 10 is called a “query sentence.” When accepting the query sentence, the processor 10 refers to the question-answer table of the first memory 21. The processor 10 verifies whether or not a question associated with the query sentence is in the question-answer table. When an associated question is found, the processor 10 outputs, to the user, a response indicating the answer to the question.

When there are multiple associated questions, the processor 10 outputs a response (a re-inquiry) for narrowing down the questions to one question. Based on the response, the user inputs another query sentence including information (a keyword) for narrowing down the question. For example, the input of the query sentence by the user and the response from the processor 10 are repeated alternately until the questions are narrowed down to one question. By answering the responses of the display control system, the user can arrive at one answer including the information sought by the user. By using the display control system 1, the user easily obtains the sought answer even when the user does not know an appropriate search method.

Whether the user arrives at the sought answer is dependent on the query sentence that is input. If the query sentence is inappropriate, the system cannot output an appropriate re-inquiry. Examples of when the query sentence is inappropriate are when the information included in the query sentence is insufficient, when the keyword (the query keyword) included in the query sentence is omitted with respect to the corresponding keyword (question keyword) inside the question-answer table, when extra characters with respect to the question keyword are added to the query keyword, when the query keyword is paraphrased with respect to the question keyword, etc.

If the query sentence is inappropriate, the system may output a response different from the intention of the user. When the system cannot output the appropriate response, it is necessary for the user to input the next query sentence so that the system can output the appropriate response. To appropriately input the next query sentence, it is desirable for the user to be able to ascertain or estimate how to input the next query sentence. However, using the response of a conventional system, it is difficult for the user to ascertain or estimate how to input the next query sentence.

In the display control system 1, for example, the processor 10 displays, in a monitor, the response to the query sentence of the user. When accepting a first sentence input by the user, the processor 10 displays, in a first screen, a first question-answer pair that includes a first question including the query keyword included in the first sentence and includes a first answer to the first question. The first question-answer pair is one of the multiple question-answer pairs included in the question-answer table. Further, the processor 10 extracts, from multiple question keywords included in the first question, a question keyword different from the query keyword. The processor 10 displays, in the first screen, a second sentence including the extracted question keyword.

In the first screen, the processor 10 displays words other than the query keyword and the question keyword in a first form. In the first screen, the processor 10 displays the query keyword in a second form different from the first form. In the first screen, the processor 10 displays the question keyword in a third form different from the first form and the second form.

For example, the processor 10 causes at least one of a color, a font, a boldness, a size, a character style, or a background color of the query keyword and the question keyword to be different from at least one of a color, a font, a boldness, a size, a character style, or a background color of the words other than these keywords. The processor 10 may mark the query keyword and the question keyword with boxes or the like surrounding these keywords.

Although the third form may be the same as the second form, it is desirable for the third form to be different from the second form. By setting the form of the display of the query keyword to be different from the form of the display of the question keyword, the user can discriminate between the query keyword and the question keyword more easily. For example, the processor 10 causes at least one of a color, a font, a boldness, a size, a character style, or a background color of the query keyword to be different from at least one of a color, a font, a boldness, a size, a character style, or a background color of the question keyword. The processor 10 may cause at least one of a shape, a color, or a size of a symbol marking the query keyword to be different from at least one of a shape, a color, or a size of a symbol marking the question keyword.

As described above, the processor 10 causes the form of the display of the query keyword and the form of the display of the question keyword used in the output sentence to be different from the form of the display of the other words. For convenience of description hereinbelow, the setting of forms of the displays of these keywords to be different from the form of the display of the other words other than these keywords also is called “emphasizing.”

An other question-answer pair (e.g., a second question-answer pair) other than the first question-answer pair may be displayed in the first screen. When multiple question-answer pairs are selected based on the first sentence, the multiple question-answer pairs are displayed in the first screen. When displaying the first question-answer pair and the second question-answer pair in the first screen, a first question keyword is used in the second sentence to narrow down the candidates from the multiple question-answer pairs to the first question-answer pair. When one question-answer pair (only the first question-answer pair) is displayed in the first screen, the first question keyword is used in the second sentence to confirm whether the first question-answer pair matches the intention of the user.

The query keyword is at least a part of the query sentence input by the user. By emphasizing the query keyword, the user can ascertain based on the query sentence what kind of keyword is set. For example, in the case where an unintended part is extracted as the keyword from the input sentence, the user ends the dialog once and inputs the next query sentence. The user inputs the next query sentence not to include the query keyword extracted from the previous query sentence.

When the question keyword used in the second sentence is emphasized, the user easily ascertains or estimates what kind of answer will be obtained by including what kind of keyword in the next query sentence. For example, multiple question-answer pairs are displayed in the first screen. The second sentence includes the first question keyword; and the first question keyword is included in the first question-answer pair. As an example, the user determines that the first question-answer pair does not match the intention of the user. At this time, based on the emphasis of the first question keyword, the user easily can ascertain or estimate that the multiple question-answer pairs can be narrowed down to a question-answer pair other than the first question-answer pair by not including the first question keyword in the next query sentence. As another example, the user determines that the first question-answer pair matches the intention of the user. At this time, based on the emphasis of the first question keyword, the user easily can ascertain or estimate that the multiple question-answer pairs can be narrowed down to the first question-answer pair by including the first question keyword in the next query sentence.

Thus, according to the first embodiment, the user easily can ascertain or estimate what kind of query sentence to input to the display control system to easily obtain the sought question-answer pair. As a result, the user arrives at the sought answer more easily. According to the first embodiment, the convenience of the display control system 1 can be improved.

The processor 10 includes a central processing unit including an electrical circuit. The first to third memories 21 to 23 each include a memory device. The memory device includes, for example, at least one of a hard disk drive (HDD), network-attached storage (NAS), an embedded multimedia card (eMMC), a solid-state drive (SSD), or a solid-state hybrid drive (SSHD). One memory device may function as the first to third memories 21 to 23. The processor 10, the first memory 21, the second memory 22, and the third memory 23 may be included in one computer or may be connected to each other via a wired technique, a wireless technique, or a network.

The display control system 1 according to the first embodiment will now be described in detail.

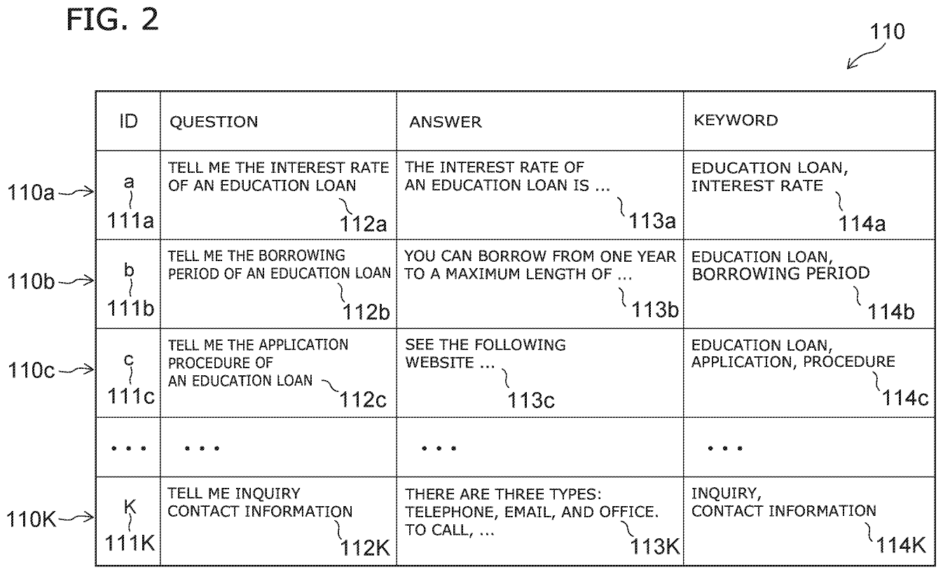

FIG. 2 is a table illustrating a question-answer table.

For example, the first memory 21 stores the question-answer table 110 shown in FIG. 2. The question-answer table 110 includes multiple question-answer pairs 110a to 110K. The question-answer pairs 110a to 110K respectively include IDs 111a to 111K identifying the question-answer pairs, questions 112a to 112K, and answers 113a to 113K to the questions.

The question-answer pairs 110a to 110K are respectively associated with question keywords 114a to 114K. For example, the question keywords 114a to 114K are included in the question-answer table 110. Or, the question keywords 114a to 114K may be stored in the first memory 21 or another memory separately from the question-answer table 110.

The question keywords 114a to 114K are extracted respectively from the questions 112a to 112K. Multiple question keywords may be extracted from one question. For example, as described below, the processor 10 extracts the question keywords 114a to 114K from the questions 112a to 112K. The question keywords 114a to 114K may be extracted by an external processing device of the display control system 1. Or, the question keywords 114a to 114K may be assigned to the questions 112a to 112K by a system administrator.

The question-answer table may include information other than the multiple question-answer pairs and the multiple question keywords. For example, the question-answer table may include a question for which a corresponding answer is not set. The question-answer table may include a combination of one or more questions and one or more answers in which a pair is not formed of one question and one answer. For example, the question-answer table includes a combination of two questions and one answer that is set as a common answer for the two questions. In such cases, for example, the processor 10 performs the dialog with the user based on only the multiple question-answer pairs. The processor 10 does not use the information other than the multiple question-answer pairs for the dialog with the user.

In the question-answer table, one answer may include multiple conditions and a detailed answer for each condition. In such a case, the multiple conditions and the multiple detailed answers can be collectively considered to be one answer.

The processor 10 includes, for example, an acceptor 11, an extractor 12, a setter 13, a selector 14, a generator 15, and an emphasizer 16.

The acceptor 11 accepts the query sentence input from the user. For example, the query sentence is input by an operation of a keyboard, a touch panel, etc., by the user. Or, the query sentence may be generated based on the user speaking. For example, a microphone records the user speaking; and the voice is recognized. The query sentence is generated by automatic speech recognition.

The extractor 12 extracts question keywords included in the question-answer table. For example, in the case where multiple question keywords are pre-registered in the question-answer table, the extractor 12 extracts the registered keywords. In the case where the keywords are not registered, the extractor 12 extracts the multiple question keywords from the question-answer table. For example, the second memory 22 stores a keyword list. The extractor 12 extracts the multiple question keywords from the question-answer table by using the keyword list. The keyword list includes multiple words that can be keywords. The extractor 12 extracts, as the question keywords, the words included in the question-answer table that match the words inside the keyword list.

The second memory 22 may store rules. The extractor 12 extracts the question keywords from the question-answer table based on the rules. As an example, a rule is recited as, “The ‘xxx’ in the sentence ‘Tell me about xxx’ is extracted as a question keyword.” The extractor 12 extracts the multiple question keywords by searching the question-answer table for sentences that satisfy the conditions recited in the rules.

The second memory 22 may store morphological analysis rules or a morphological analysis model. Based on the morphological analysis rules or the morphological analysis model, the extractor 12 performs morphological analysis of the sentence included in each question-answer pair of the question-answer table. By performing morphological analysis of the sentence, the extractor 12 splits the sentence into multiple words and estimates the part of speech of each word. The extractor 12 sets the words of designated parts of speech as the keywords. For example, nouns and verbs are used as the designated parts of speech. For a compound noun which is one type of noun, the extractor 12 may register each noun inside the compound noun as a keyword, may register the entire compound noun as one keyword, or may register using a combination of these techniques. Also, the extractor 12 may extract, as a keyword, a word (an unknown word) that cannot be classified as any part of speech.

The timing of the extractor 12 extracting the multiple question keywords from the question-answer table is arbitrary. For example, the extractor 12 extracts the multiple question keywords from the question-answer table when the acceptor 11 accepts the query sentence input by the user. The extractor 12 may extract the multiple question keywords before the acceptor 11 accepts the input of the query sentence.

The setter 13 sets the query keyword based on the query sentence. For example, the setter 13 extracts the query keyword from the query sentence. Similarly to the extractor 12, the setter 13 may extract the query keyword from the query sentence by using a keyword list. The setter 13 may extract the query keyword based on rules. The setter 13 may extract the keyword based on a morphological analysis result of the query sentence. The setter 13 may set the entire query sentence as one query keyword. In the case where the entire query sentence is set as one query keyword and the multiple question keywords are pre-registered, the second memory 22 is unnecessary.

The selector 14 searches whether or not question keywords that match the query keyword are included in the multiple question keywords extracted by the extractor 12. When a question keyword matching the query keyword is included, the selector 14 selects the question-answer pair including the question keyword as a candidate of the answer sought by the user. The selector 14 acquires the question and the answer included in the selected question-answer pair, the ID of the selected question-answer pair, and the question keyword included in the question of the selected question-answer pair.

When multiple query keywords are set by the setter 13, for example, the selector 14 selects question-answer pairs including multiple question keywords matching all of the multiple query keywords. Or, the selector 14 may select question-answer pairs including one or more question keywords matching one or more of the multiple query keywords.

The selector 14 may calculate the similarity between the query keyword and each of the multiple question keywords when comparing the query keyword and the multiple extracted question keywords. For example, the selector 14 calculates the edit distance between the query keyword and each of the multiple question keywords. When the edit distance between the question keyword and the query keyword exceeds a threshold, the selector 14 determines the question keyword to be similar to the query keyword. For example, the question keyword that is similar to the query keyword is a paraphrase of the query keyword.

For example, the reading of one question keyword is the same as the reading of one query keyword. As an example, at least a part of the question keyword is written using one of hiragana or katakana; and at least a part of the query keyword is written using the other of hiragana or katakana. In such a case, the question keyword is a paraphrase of the query keyword. As another example, the question keyword and the query keyword include the same kanji but include different declensional kana. Even in such a case, the question keyword is a paraphrase of the query keyword.

Also, when the question keyword and the query keyword include the same kanji but have different declensional kana due to different parts of speech, the question keyword is determined to be a paraphrase of the query keyword. For example, when the question keyword is “furikomi (a transfer)” and the query keyword is “furikomu (to transfer),” the question keyword is determined to be a paraphrase of the query keyword.

A paraphrase list may be pre-generated. The list includes multiple pairs of keywords. The keywords that are recited in the pairs are paraphrases of each other. The selector 14 determines whether or not question keywords that are paraphrases of the query keyword are included in the multiple question keywords while referring to the list.

The similarity may be determined using a pre-trained distributed representation model. A distributed representation of words is described in the distributed representation model. The selector 14 determines the similarity based on the distance or the cosine similarity between the vectors of the keywords. The selector 14 calculates the similarity between the query keyword and each of the multiple question keywords. When the similarity between the question keyword and the query keyword exceeds a threshold, the selector 14 determines that the question keyword is similar to the query keyword.

The generator 15 generates a response based on the query keyword, the selected question-answer pairs, and the question keywords included in the selected question-answer pairs. Specifically, the generator 15 outputs at least a part of each selected question-answer pair, and generates and outputs a sentence.

When the number of selected question-answer pairs is two or more, the generator 15 outputs at least a part of each of the two or more question-answer pairs, and outputs a sentence requesting the user to input a query sentence for narrowing down the question-answer pairs.

When the number of selected question-answer pairs is one, the generator 15 outputs at least a part of the one question-answer pair, and outputs a sentence requesting the user to confirm whether or not the question-answer pair matches the intention of the user.

When the number of selected question-answer pairs is 0, for example, the generator 15 outputs a sentence requesting the input of another query sentence. The sentence may be a fixed phrase such as an apology indicating that the question-answer pair could not be found, etc.

For example, the sentence that is included in the response from the generator 15 is generated based on a generic model stored in the third memory 23. The generic model includes multiple scenario templates. The generator 15 determines the scenario template to be used according to the number of selected question-answer pairs. Each scenario template is described generically not to be dependent on the inquiry of the user. Specifically, each scenario template includes blanks. A question, an answer, or a question keyword is plugged into each blank.

For example, the task model includes “Your question is blank 1. Blank 2” as the scenario template used when a number N of the selected question-answer pair is 1. The task model includes “Are there additional keywords such as blank 4a, blank 4b, blank 4Nk, or the like?” as the scenario template used when the number N is 2 or more.

When the number N is 1, the generator 15 substitutes the question of the selected question-answer pair into blank 1. The answer of the selected question-answer pair is substituted into blank 2. When the number N is 2 or more, the generator 15 extracts, from each of the multiple selected question-answer pairs, one question keyword that is different from the query keyword. The generator 15 substitutes the multiple extracted question keywords respectively into blank 4a, blank 4b, . . . , and blank 4Nk.

As an example, the query sentence that is input by the user includes the query keyword “interest rate.” In the question-answer table shown in FIG. 2, for example, only the question-answer pair 110a includes the question keyword “interest rate.” When the selector 14 selects only the question-answer pair 110a, the generator 15 substitutes the question 112a into blank 1 and substitutes the answer 113a into blank 2. Thereby, the sentence of “Your question is ‘Tell me the interest rate of an education loan.’ The interest rate of an education loan is . . . ” is generated.

As another example, the query sentence that is input by the user includes the query keyword “education loan.” In the question-answer table shown in FIG. 2, for example, the question-answer pairs 110a to 110c include the question keyword “education loan.” The selector 14 selects the question-answer pairs 110a to 110c. The generator 15 extracts, from the question-answer pairs 110a to 110c, for example, the question keywords “interest rate,” “borrowing period,” and “application” which are different from the query keyword. The generator 15 substitutes these question keywords respectively into blank 4a, blank 4b, and blank 4c. Thereby, the sentence of “Are there additional keywords such as interest rate, borrowing period, application, or the like?” is generated.

The specific content of the scenario templates included in the generic model is not limited to the examples recited above and is modifiable as appropriate. The generic model may include more scenario templates corresponding to the number N.

When generating a response including one or more question-answer pairs, the generator 15 displays the query keyword and question keywords that are different from the query keyword. For example, the question keywords are included in the sentence. The query keyword is displayed as being included in the question-answer pair. Or, the query keyword is displayed to accompany the question-answer pairs. The emphasizer 16 assigns flags to the generated response so that the query keyword and the question keywords included in the sentence are displayed as being emphasized in the response. Or, the emphasizer 16 may assign flags to the generated response so that words other than the query keyword and the question keywords included in the sentence are more noticeable than the query keyword and the question keywords included in the sentence in the response.

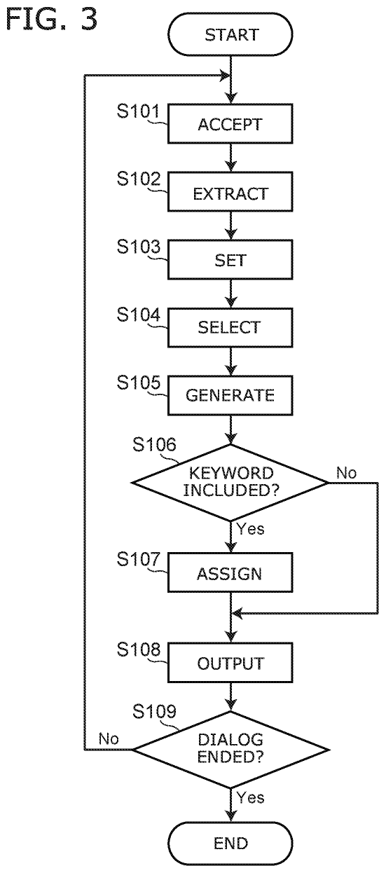

FIG. 3 is a flowchart illustrating the processing of the display control system according to the first embodiment.

The acceptor 11 accepts the query sentence input by the user (step S101). The extractor 12 extracts a question keyword from each question-answer pair of the question-answer table (step S102). The setter 13 sets one or more query keywords based on the query sentence (step S103). The selector 14 compares the multiple question keywords and the one or more query keywords and selects one or more question-answer pairs from the question-answer table (step S104). The generator 15 generates a response based on the extracted query keyword, the selected question-answer pairs, and the question keywords included in the selected question-answer pairs (step S105). The emphasizer 16 determines whether or not the generated response includes the query keyword and a question keyword (step S106). When the response includes these keywords, the emphasizer 16 assigns emphasis flags to the response (step S107). When the response does not include a keyword, the emphasizer 16 does not assign an emphasis flag to the response. The emphasizer 16 outputs the response to a monitor (step S108). Thereby, the response is displayed in the monitor.

After outputting the response, the processor 10 determines whether or not the dialog has ended (step S109). For example, the processor 10 measures the elapsed time after the response was output. The processor 10 determines that the dialog has ended when the elapsed time exceeds a threshold without the user inputting another query sentence. A sentence that indicates that the dialog has ended may be input from the user to the display control system 1. When accepting such a sentence, the processor 10 determines that the dialog has ended. If the acceptor 11 accepts the next query sentence before such conditions of the end are satisfied, the processor 10 re-performs the processing described above.

The response may be output so that the question, the keyword, etc., can be selected on a graphical user interface (GUI) displayed in the monitor. For example, when the response includes a question keyword, the question keyword may be selectable on the GUI. When the user clicks the question keyword on the GUI, the clicked question keyword is input to the processor 10 as the next query sentence.

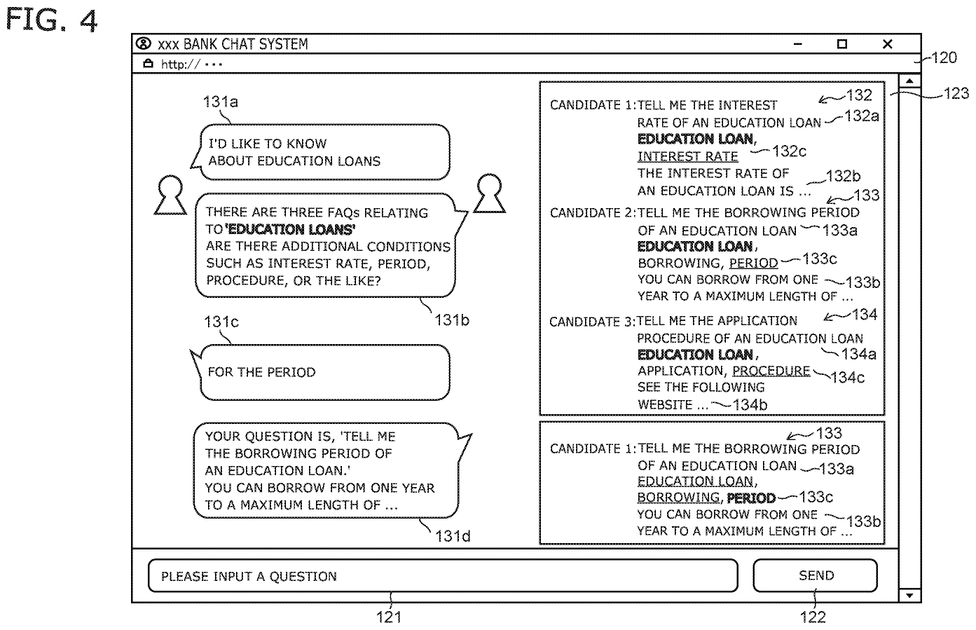

FIG. 4 to FIG. 6 are schematic views illustrating outputs of the display control system according to the first embodiment.

FIG. 4 to FIG. 6 illustrate the operation when the processor 10 responds based on the question-answer table of a bank. FIG. 4 to FIG. 6 show examples when the response is output to a display device (a monitor).

For example, as shown in FIG. 4 to FIG. 6, a window 120 (an example of the first screen) is displayed in the monitor. The window 120 includes an input field 121, an icon 122, and a display region 123. When the user inputs a sentence using a keyboard, a touch panel, a microphone, etc., the sentence is displayed in the input field 121. The user can input the sentence to the processor 10 by clicking the icon 122. The sentence input to the processor 10, the response from the processor 10, etc., are displayed in the display region 123.

In the example of FIG. 4, the user inputs, to the display control system 1, a query sentence 131a of “I'd like to know about education loans.” The acceptor 11 accepts the input query sentence 131a. The extractor 12 refers to the question-answer table that is pre-generated by the bank. For example, the extractor 12 performs morphological analysis of each question of the question-answer table. The extractor 12 estimates the part of speech of each of the multiple words included in each question. The extractor 12 sets, as question keywords, the words of which the part of speech is a noun. Similarly to the extractor 12, the setter 13 performs morphological analysis of the query sentence. The setter 13 sets, as the query keywords, the words of which the part of speech is a noun. In the example of FIG. 4, “education loan” is extracted as the query keyword.

The selector 14 searches the multiple question keywords for question keywords that match or are similar to “education loan.” As a result of the search, for example, the three questions of “Tell me the interest rate of an education loan,” “Tell me the borrowing period of an education loan,” and “Tell me the application procedure of an education loan” are found in the question-answer table. The selector 14 selects, from the question-answer table, the three question-answer pairs that include these three questions.

Because multiple question-answer pairs are selected, the generator 15 generates a response (a re-inquiry) for narrowing down the question-answer pairs. The generator 15 extracts multiple question keywords that are included in the multiple selected question-answer pairs and are different from the query keyword. In the example of FIG. 4, “interest rate,” “period,” and “procedure” are extracted as question keywords for the re-inquiry. The generator 15 generates a response including the three question-answer pairs, the query keyword, and the question keywords different from the query keyword.

The emphasizer 16 assigns, to the generated response, flags emphasizing the query keyword and the question keywords. For example, the emphasizer 16 displays the query keyword “education loan” in boldface. By the display, the user can know what kind of query keyword was set and used to search the question-answer pairs based on the query sentence input by the user. Also, the emphasizer 16 displays the questions including the query keyword and underlines the question keywords “interest rate,” “period,” and “procedure” which are different from the query keyword. By the display, the user can ascertain or estimate how to narrow down the question-answer pairs by including what keyword in the next query sentence.

For example, as shown in FIG. 4, a query sentence 131b and question-answer pairs 132 to 134 are displayed in the window 120. The sentence 131b includes question keywords for narrowing down the question-answer pairs. The question-answer pairs 132 to 134 respectively include questions 132a to 134a including the query keyword, and answers 132b to 134b to the questions 132a to 134a.

In the example of FIG. 4, question keywords 132c to 134c are displayed to accompany the question-answer pairs 132 to 134 displayed as candidates. The question keywords 132c to 134c each include the query keyword and a question keyword different from the query keyword. In each of the question keywords 132c to 134c, the query keyword, the question keyword included in the sentence 131b, and the other question keywords are displayed in mutually-different forms. Or, the query keyword, the question keyword included in the sentence 131b, and the other question keywords may be displayed in mutually-different forms in the questions 132a to 134a instead of displaying the question keywords 132c to 134c.

In the example of FIG. 4, the sentence 131b includes the query keyword. For example, the query keyword that is included in the sentence is displayed in a form different from that of the other words included in the sentence. In the example of FIG. 4, the question keywords that are included in the sentence may be displayed in forms different from that of the other words included in the sentence.

For example, as shown in FIG. 4, the entire question and the entire answer are displayed in the window 120 for each of the selected question-answer pairs. Or, a part of the question and a part of the answer may be displayed in the window 120 for each of the selected question-answer pairs. A part of the question, a URL where the answer is recited, etc., may be displayed in the window 120 for each of the selected question-answer pairs. It is sufficient for at least one of at least a part of the question or at least a part of the answer to be displayed for each of the selected question-answer pairs in the window 120.

For example, the user confirms the emphasized query keyword and question keywords and inputs a query sentence 131c of “For the period” to the display control system 1. Based on the query sentence, the setter 13 sets “period” as the query keyword. Based on the query keyword, the selector 14 narrows down the previously-selected question-answer pairs 132 to 134 to the question-answer pair 133. Based on the narrowing down, the processor 10 confirms whether or not the question 133a is appropriate for the inquiry of the user by outputting a sentence 131d of “Your question is, ‘Tell me the borrowing period of an education loan.’ You can borrow from one year to a maximum length of . . . .”

The processing of the display control system 1 according to the first embodiment will now be described by comparing to the specific example of FIG. 4.

When the user inputs the first sentence including a first query keyword, the processor 10 displays the second sentence and at least a part of the first question-answer pair. The first question-answer pair includes the first question including the first query keyword, and the first answer to the first question. The second sentence includes the first question keyword included in the first question. In the display, the processor 10 displays words other than the first query keyword and the first question keyword in the first form, displays the first query keyword in the second form different from the first form, and displays the first question keyword in the third form different from the first form and the second form.

For example, the first sentence corresponds to the query sentence 131a. For example, the first query keyword corresponds to the query keyword “education loan.” For example, the first question-answer pair corresponds to the question-answer pair 133. For example, the first question keyword corresponds to the question keyword “period.” For example, the second form corresponds to boldface. For example, the third form corresponds to underlining. For example, the first form corresponds to plain type which is neither boldface nor underlining.

For example, the first question further includes a second question keyword that is different from the first query keyword and the first question keyword. The second sentence does not include the second question keyword. In the display, the second question keyword is displayed in the third form.

For example, the second question keyword corresponds to the question keyword “borrowing.” The sentence 131b does not include the question keyword “borrowing.” In the question keyword 133c, the question keyword “borrowing” is displayed in plain type which is neither boldface nor underlined.

For example, in the display recited above, the processor 10 further displays at least a part of the second question-answer pair including a second question including the first query keyword and a second answer to the second question. The second sentence further includes a third question keyword included in the second question. In the display, the words other than the first query keyword, the first question keyword, and the third question keyword are displayed in the first form; the first query keyword is displayed in the second form; and the first question keyword and the third question keyword are displayed in the third form.

For example, the second question-answer pair corresponds to the question-answer pair 134. For example, the third question keyword corresponds to the question keyword “procedure.” In the question keyword 134c, the question keywords other than “education loan” and “procedure” are displayed in plain type.

After the display recited above, when the user inputs a third sentence including one of the first question keyword or the third question keyword, the processor 10 displays at least a part of one of the first question-answer pair or a third question-answer pair including the one of the first question keyword or the third question keyword.

For example, the third sentence corresponds to the query sentence 131c. The query sentence 131c includes “period” which is one of “period” or “procedure.” After the query sentence 131c is input, the processor 10 displays at least a part of the question-answer pair 133 including the question keyword “period.”

The processor 10 may determine whether or not the query sentence is a negative sentence. For example, when setting the query keyword, the setter 13 determines whether or not the query sentence is a negative sentence. When the setter 13 determines that the query sentence is a negative sentence, the selector 14 selects question-answer pairs that do not include the query keyword.

For example, after the display control system 1 outputs the query sentence 131b, the user inputs the query sentence of “Not ‘interest rate’ or ‘procedure.’” The setter 13 extracts “interest rate” and “procedure” from the query sentence as query keywords. Further, the setter 13 determines that the query sentence is a negative sentence. Based on the determination result, the selector 14 selects a question-answer pair that does not include the question keywords of “interest rate” and “procedure” from the three previously-selected question-answer pairs. As a result, the display control system 1 outputs the sentence 131d.

To determine whether or not the query sentence is a negative sentence, for example, the setter 13 refers to pre-generated rules. As an example, a rule is recited as, “The query sentence is a negative sentence when ‘not,’ ‘non,’ or ‘other than’ are included in the query sentence. The setter 13 determines whether or not the query sentence is a negative sentence by determining whether the query sentence satisfies the conditions recited in the rules.

The setter 13 may refer to a pre-generated model. For example, the model is an artificial neural network model or a recurrent neural network model. The model is pre-trained using training data. The training data includes multiple paired data. Each paired data includes a sentence and information indicating that the sentence is the negative form. The model is trained to output information indicating a negative sentence when a negative sentence is input.

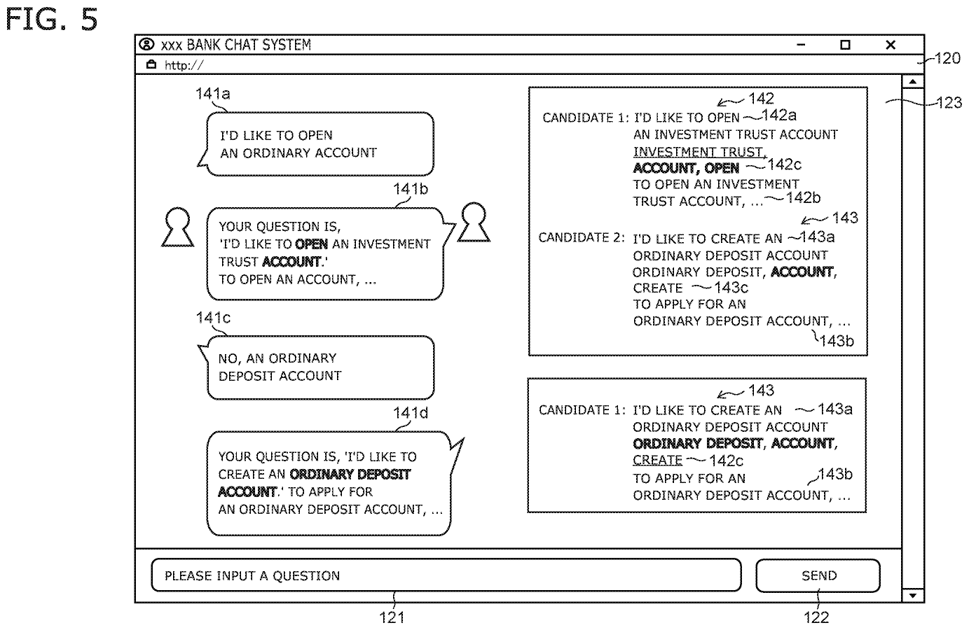

In the example of FIG. 5, the user inputs, to the display control system 1, a query sentence 141a of “I'd like to open an ordinary account.” The setter 13 extracts, from the query sentence 141a, “ordinary,” “account,” and “open” as query keywords. Based on these query keywords, the selector 14 selects question-answer pairs 142 and 143. The question-answer pair 142 includes a question 142a and an answer 142b. The question-answer pair 143 includes a question 143a and an answer 143b. Question keywords 142c and 143c are question keywords respectively included in the questions 142a and 143a. The question keywords 142c include the three question keywords of “investment trust,” “account,” and “open.” The question keywords 143c include the three question keywords of “ordinary deposit,” “account,” and “create.”

In the example of FIG. 5, the question keywords 142c include “account” and “open” corresponding to two of the three query keywords. The question keywords 143c include “account” which is one of the three query keywords. In other words, the question 142a includes more query keywords. For example, the generator 15 confirms whether or not the question 142a is appropriate for the inquiry of the user by outputting a sentence 141b of “Your question is, ‘I'd like to open an investment trust account.’ To open an account, . . . ” The emphasizer 16 displays “account” and “open” corresponding to the query keywords and the question keyword “investment trust” included in the sentence 141b to be emphasized compared to the other words. The question keyword “investment trust” that is included in the sentence 141b is displayed to be emphasized compared to the other question keywords “ordinary deposit” and “create.”

For example, in the query sentence 141a, the user meant “ordinary deposit” when inputting “ordinary.” In such a case, the content of the sentence 141b does not match the intention of the user. This is because an investment trust is being confirmed even though the intention of the user is an ordinary deposit. On the other hand, the selected question-answer pair 143 includes a question matching the intention of the user.

By viewing the emphasized query keyword, the user can ascertain or estimate the reason that the sentence 141b is output from the display control system 1. In the example of FIG. 5, although the user meant an ordinary deposit when inputting “ordinary,” it can be seen that “ordinary deposit” is not emphasized at all in the response. Based on the response, the user can recognize that the input of “ordinary” is inappropriate, and “ordinary deposit” should be input.

For example, the user confirms the emphasized query keyword and question keywords, corrects “ordinary” to “ordinary deposit,” and inputs, to the display control system 1, a query sentence 141c of “No, an ordinary deposit account.” Based on the query sentence 141c, the processor 10 narrows down the previously-selected question-answer pairs 142 and 143 to the question-answer pair 143. Based on the narrowing down, the processor 10 confirms whether or not the question 143a is appropriate for the inquiry of the user by outputting a sentence 141d of “Your question is, ‘I'd like to create an ordinary deposit account.’ To apply for an ordinary deposit account, . . . .’”

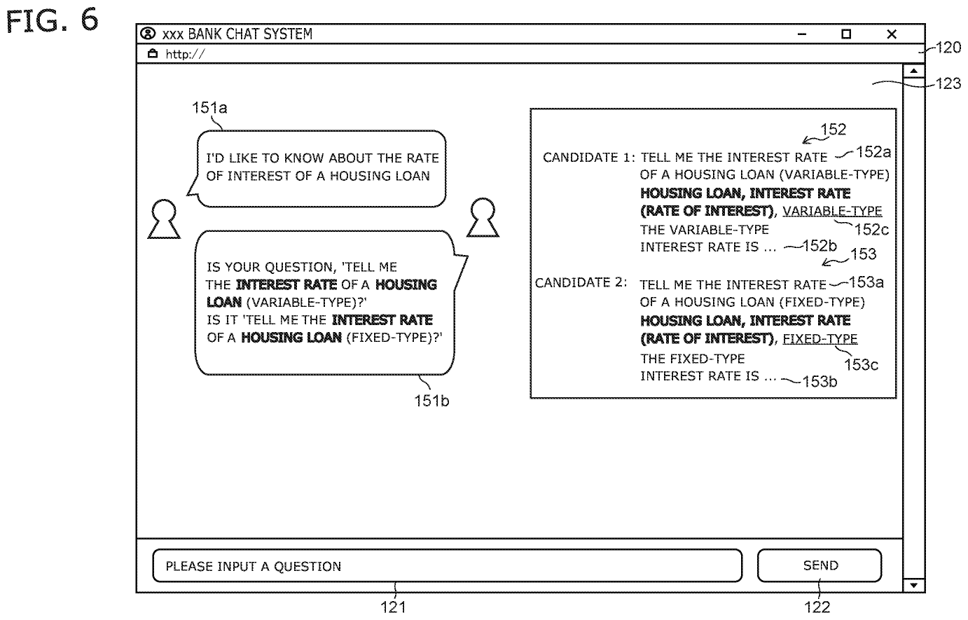

FIG. 6 shows an example of a result in which the similarity between the query keyword and the question keyword is determined. In the example of FIG. 6, the user inputs a query sentence 151a of “I'd like to know about the rate of interest of a housing loan.” Based on the query sentence, “housing loan” and “rate of interest” (an example of a first similar keyword) are set as the query keywords. For example, in question-answer pairs 152 and 153, questions 152a and 153a include “housing loan” and “interest rate” as question keywords.

The selector 14 determines that “interest rate” is a paraphrase similar to “rate of interest.” The emphasizer 16 not only emphasizes “housing loan” as the query keyword but also emphasizes “interest rate” as a question keyword corresponding to the query keyword. For example, the emphasizer 16 displays “interest rate” in the same form as the form of the display of “housing loan.” The emphasizer 16 displays the question keywords “variable-type” and “fixed-type” included in a sentence 151b by emphasizing in a form different from that of “housing loan” and “interest rate.”

By emphasizing the paraphrase, the user easily understands that the paraphrase is used to search the question-answer pairs.

### Second Embodiment

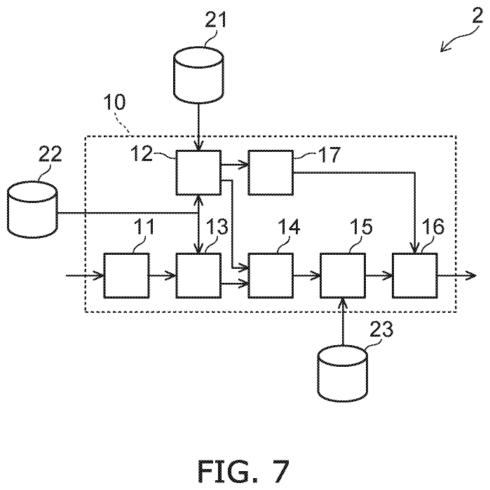

FIG. 7 is a schematic view illustrating a display control system according to a second embodiment.

In the display control system 2 according to the second embodiment, the emphasized question keywords are determined based on the score of each question keyword. For example, in the display control system 2 as shown in FIG. 7, the processor 10 further includes a determiner 17.

The determiner 17 determines the score of each question keyword extracted by the extractor 12. The score of the question keyword is set to be higher for a fewer number of question-answer pairs including the question keyword. In other words, the number of candidates when the question keyword is included in the query sentence is lower for a higher score of the question keyword. The determiner 17 determines the score of each question keyword using a technique such as the appearance frequency in the question-answer table, the inverse document frequency in the question-answer table, BM25, etc. For example, the determiner 17 calculates the proportion of the number of question-answer pairs including the question keyword to the total number of question-answer pairs included in the question-answer table. The determiner 17 uses the reciprocal of the proportion (the inverse document frequency) as the score. Or, the determiner 17 may set a numerical value set based on the proportion as the score. For example, the determiner 17 may convert the reciprocal of the proportion using a logarithmic function and may use the obtained numerical value as the score.

For example, the question-answer table is taken to include the four question-answer pairs 110a, 110b, 110c, and 110K as shown in FIG. 2. When the query sentence includes “education loan,” the three question-answer pairs 110a to 110c are selected. The determiner 17 determines the score of the question keyword “education loan” to be 4/3 which is the reciprocal of 3/4. When the query sentence includes “interest rate,” the one question-answer pair 110a is selected. The determiner 17 determines the score of the question keyword “interest rate” to be 4/1 which is the reciprocal of 1/4. The determiner 17 similarly determines the scores of the other question keywords.

The emphasizer 16 assigns flags to the response based on the response generated by the generator 15 and the scores determined by the determiner 17. For example, the emphasizer 16 changes the form of the output according to the scores. For example, the emphasizer 16 assigns a flag so that the question keyword is displayed to be larger, bolder, or with a darker color for a higher score of the question keyword.

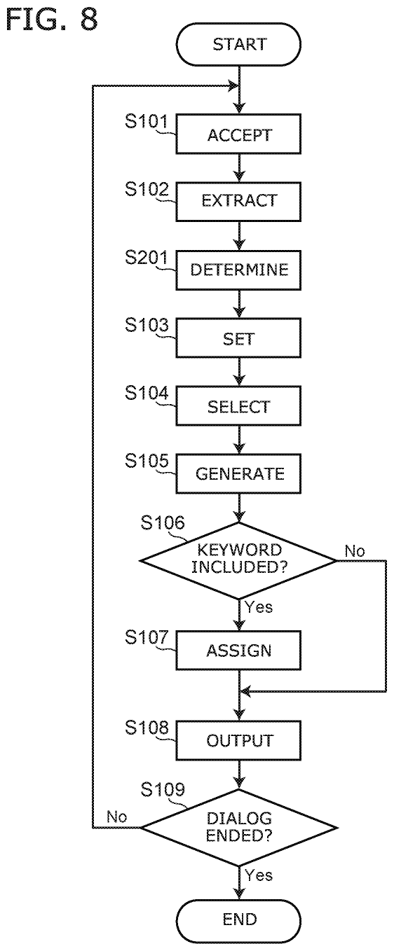

FIG. 8 is a flowchart illustrating the processing of the display control system according to the second embodiment.

Steps S101 to S106, S108, and S109 of the flowchart shown in FIG. 8 are similar to S101 to S106, S108, and S109 of the flowchart shown in FIG. 3. When multiple question keywords are extracted in step S102, the determiner 17 determines the score of each question keyword (step S201). When it is determined that the query keyword and the question keyword are included in the response generated in step S106, the emphasizer 16 assigns flags to the response based on the score (step S107).

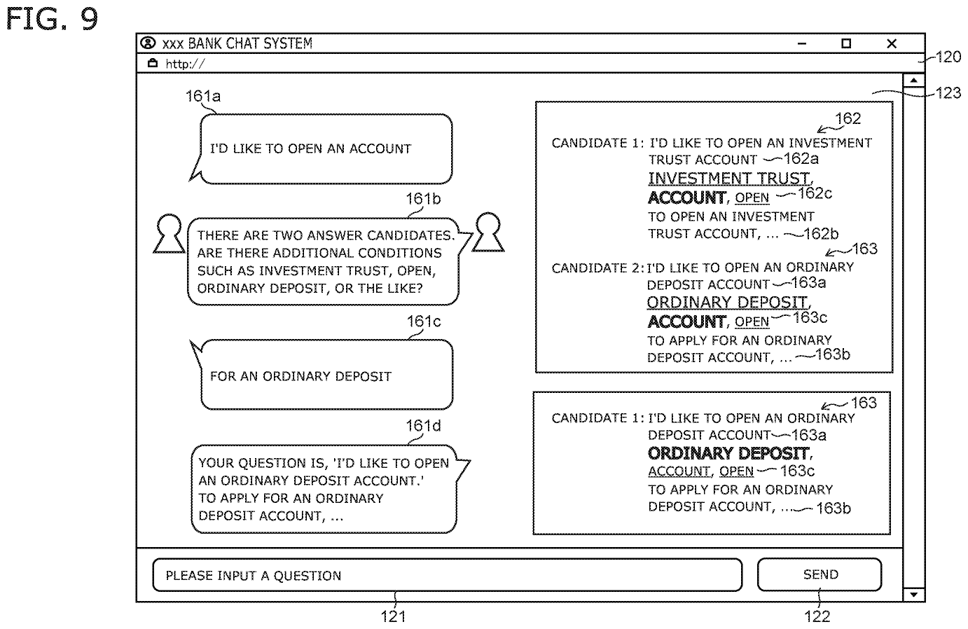

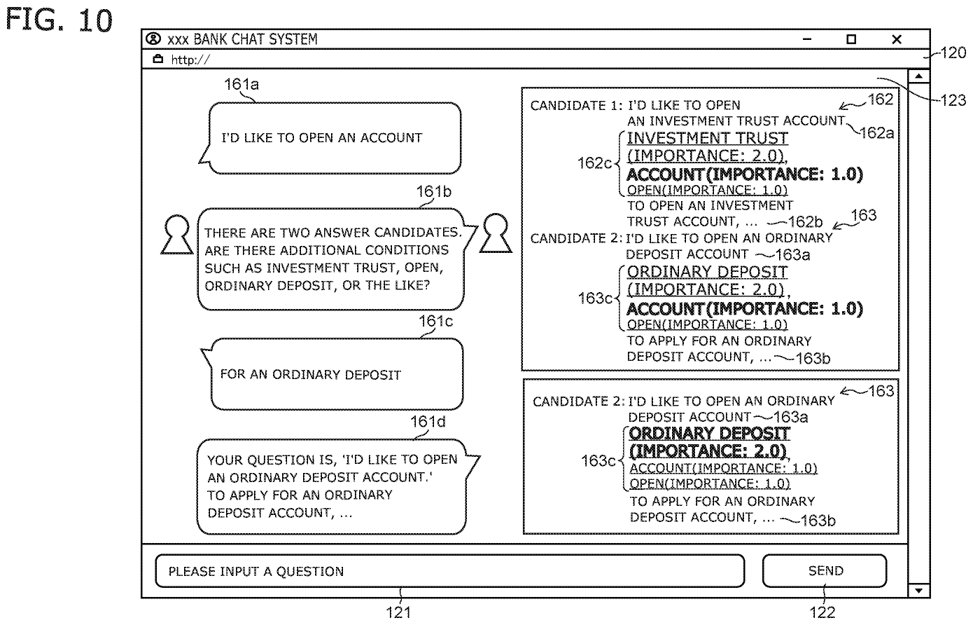

FIG. 9 and FIG. 10 are schematic views illustrating outputs of the display control system according to the second embodiment.

Similarly to FIG. 4 to FIG. 6, FIG. 9 and FIG. 10 illustrate the operation when the processor 10 responds based on the question-answer table of a bank.

In the examples of FIG. 9 and FIG. 10, the user inputs a query sentence 161a of “I'd like to open an account” to the display control system 2. The setter 13 extracts “account” as a query keyword from the query sentence 161a. The selector 14 selects question-answer pairs 162 and 163 based on the query keyword. The question-answer pair 162 includes a question 162a and an answer 162b. The question-answer pair 163 includes a question 163a and an answer 163b. Question keywords 162c and 163c are question keywords included respectively in the questions 162a and 163a. The question keywords 162c include the three question keywords of “investment trust,” “account,” and “open.” The question keywords 163c include the three question keywords of “ordinary deposit,” “account,” and “open.”

Based on the selected question-answer pairs 162 and 163 and the question keywords 162c and 163c, the generator 15 generates a sentence 161b of “There are two answer candidates. Are there additional conditions such as investment trust, open, ordinary deposit, or the like?.” The emphasizer 16 assigns flags to the response for emphasizing and displaying “account” which is the query keyword and the three question keywords of “investment trust,” “open,” and “ordinary deposit” included in the sentence 161b.

For example, the scores of “investment trust” and “ordinary deposit” are higher than the score of “open.” The emphasizer 16 assigns flags to the response so that “investment trust” and “ordinary deposit” are displayed in the third form, and “open” is displayed in the fourth form. In the example of FIG. 9, the emphasizer 16 assigns flags to the response so that “investment trust” and “ordinary deposit” are displayed to be larger than “open.” As shown in FIG. 10, information that indicates the score of each question keyword included in the question keywords 162c and 163c may be displayed. In the example of FIG. 10, the score is displayed by the characters “importance” and a numeral indicating the score.

In the example of FIG. 10, the score of “account” is lower than the scores of “investment trust” and “ordinary deposit.” However, “account” matches the query keyword. For example, as shown in FIG. 10, the emphasizer 16 assigns the flags so that the question keyword matching the query keyword is emphasized more regardless of the score.

By changing the forms of the output according to the score, the user easily understands which question keyword is more important (has a higher score). By using an important keyword when the user inputs the next query sentence, the user easily narrows down the question-answer pairs used as candidates. Therefore, the user arrives at the sought answer more quickly.

In the examples of FIG. 9 and FIG. 10, the user receives the response including the sentence 161b and inputs a query sentence 161c of “For an ordinary deposit” to the display control system 2. Based on the query sentence 161c, the processor 10 narrows down the previously-selected question-answer pairs 162 and 163 to the question-answer pair 163. Based on the narrowing down, the processor 10 confirms whether or not the question 163a is appropriate for the inquiry of the user and outputs a sentence 161d of “Your question is, ‘I'd like to open an ordinary deposit account.’ To apply for an ordinary deposit account, . . . .”

### Modification

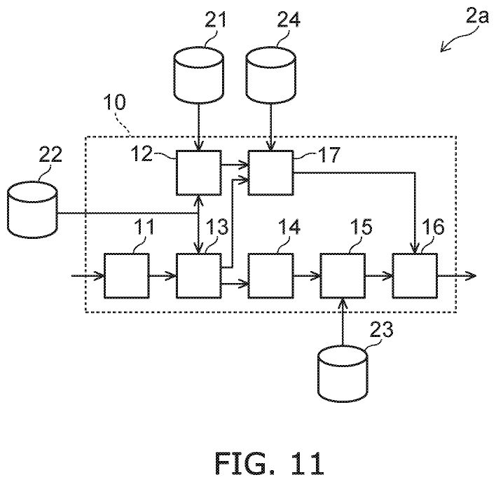

FIG. 11 is a schematic view illustrating a display control system according to a modification of the second embodiment.

In the display control system 2a according to the modification, the determiner 17 determines the flags for emphasizing the question keywords based on similarities between the query keyword and each question keyword.

For example, as shown in FIG. 11, the determiner 17 refers to a fourth memory 24. The fourth memory 24 stores a pre-generated thesaurus. The display control system 2a may include the fourth memory 24. The fourth memory 24 includes a memory device. The memory device includes, for example, at least one of a HDD, NAS, an eMMC, a SSD, or a SSHD. One memory device may function as the first to fourth memories 21 to 24.

The thesaurus includes pairs of mutually-similar keywords, and the similarity between the keywords. For example, the pair of keywords and the similarity are recited as “interest rate-rate of interest, 0.9.”

When the extractor 12 extracts multiple question keywords and the setter 13 sets a query keyword, the determiner 17 refers to the thesaurus of the fourth memory 24. The determiner 17 calculates the similarities between the query keyword and each question keyword and determines the score of each question keyword based on the similarity.

The determiner 17 may determine the score of each question keyword without referring to the thesaurus. For example, the determiner 17 may determine the similarity based on the number of characters matching between the question keyword and the query keyword. When the question keyword and the query keyword each include multiple words, the determiner 17 may determine the similarity based on the number of words matching between the question keyword and the query keyword. Or, the determiner 17 may calculate the edit distances between the query keyword and each question keyword. The determiner 17 compares the edit distance and a threshold. The question keywords for which an edit distance exceeding the threshold is calculated are determined to be similar to the query keyword. When the question keyword is determined to be similar to the query keyword, the determiner 17 determines the edit distance between the question keyword and the query keyword to be the score of the question keyword. For example, the score of a question keyword not similar to the query keyword is determined to be 0. Instead of directly using the edit distance, the determiner 17 may use the edit distance normalized using at least one of the character count of the query keyword or the character count of the question keyword.

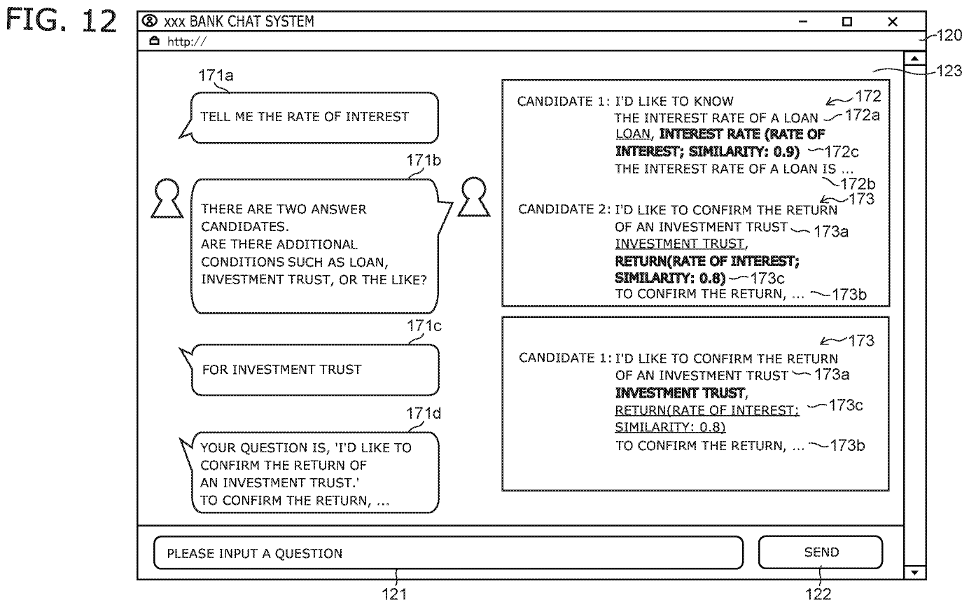

FIG. 12 is a schematic view illustrating the output of the display control system according to the modification of the second embodiment.

Similarly to FIG. 9 and FIG. 10, FIG. 12 illustrates the operation when the processor 10 responds based on the question-answer table of a bank.

In the example of FIG. 12, the user inputs a query sentence 171a of “Tell me the rate of interest” to the display control system 2a. The setter 13 extracts “rate of interest” from the query sentence 171a as the query keyword. Based on the query keyword, the selector 14 selects question-answer pairs 172 and 173. The question-answer pair 172 includes a question 172a and an answer 172b. The question-answer pair 173 includes a question 173a and an answer 173b. Question keywords 172c and 173c are question keywords included respectively in the questions 172a and 173a.

The question keywords 172c include the two question keywords of “loan” and “interest rate.” The question keywords 173c include the two question keywords of “investment trust” and “return.” The generator 15 extracts “loan” and “investment trust” from the question keywords 172c and 173c as question keywords not matching the query keyword. The generator 15 generates a sentence 171b of “There are two answer candidates. Are there additional conditions such as loan, investment trust, or the like?” for narrowing down the question-answer pairs.

In the example of FIG. 12, the similarity between “interest rate” and “rate of interest” is 0.9. The similarity between “interest rate” and “return” is 0.8. For example, as shown in FIG. 12, the emphasizer 16 emphasizes the query keyword and the question keywords and provides the display of the similarities for the question keywords.

For example, the user inputs the query sentence 171a because the user would like to know the return of an investment trust. As shown in FIG. 12, the candidates of the question-answer pairs for the query sentence 171a are displayed. In such a case, it is difficult for the user to estimate why the question-answer pair 172 is displayed at the highest rank only based on the sentence 171b and the emphasized displays of the query keyword and the question keywords. By including the similarities between the query keyword and the question keywords in the response, the user easily understands the basis of the ranking of the question-answer pairs.

In the example of FIG. 12, the user receives the response including the sentence 171b, and inputs a query sentence 171c of “For an investment trust” to the display control system 2a. Based on the query sentence 171c, the processor 10 narrows down the previously-selected question-answer pairs 172 and 173 to the question-answer pair 173. Based on the narrowing down, the processor 10 confirms whether or not the question 173a is appropriate for the inquiry of the user by outputting a sentence 171d of “Your question is, ‘I'd like to confirm the return of an investment trust.’ To confirm the return, . . . .”

When calculating the similarity, the determiner 17 may determine a value indicating the unfamiliarity of the query keyword. The emphasizer 16 changes the form of the emphasis in the response based on the value. For example, when determining the similarity between the query keyword and the question keyword based on the edit distance or the number of matching characters, the determiner 17 compares the similarity to a first threshold and a second threshold. The first threshold is less than the second threshold. When the similarity is larger than the first threshold and smaller than the second threshold, the determiner 17 determines that the question keyword is an unknown word. The determiner 17 determines a value indicating the unfamiliarity based on the similarity, the first threshold, and the second threshold. When the query keyword is a phrase made of multiple words such as a compound noun, etc., the determiner 17 determines that the query keyword is an unknown word when the number of partially-matching characters is larger than a third threshold and smaller than a fourth threshold.

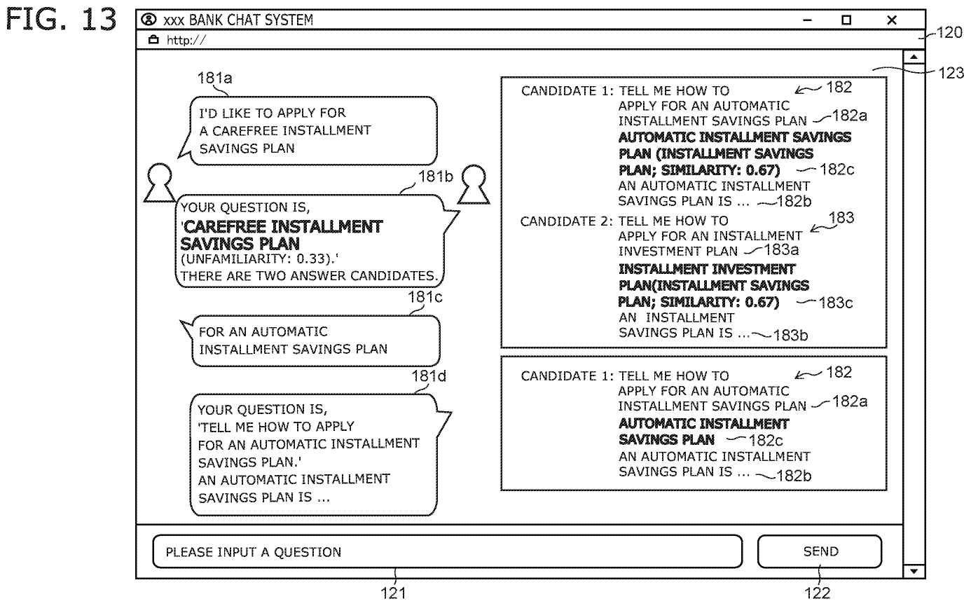

FIG. 13 is a schematic view illustrating the output of the display control system according to the modification of the second embodiment.

Similarly to FIG. 9 and FIG. 10, FIG. 13 illustrates the operation when the processor 10 responds based on the question-answer table of a bank.

In the example of FIG. 13, the user inputs a query sentence 181a of “I'd like to apply for a carefree installment savings plan” to the display control system 2a. The setter 13 extracts “carefree installment savings plan” from the query sentence 181a as a query keyword. Based on the query keyword, the selector 14 selects question-answer pairs 182 and 183. The question-answer pair 182 includes a question 182a and an answer 182b. The question-answer pair 183 includes a question 183a and an answer 183b. Question keywords 182c and 183c are question keywords included respectively in the questions 182a and 183a.

The question keyword 182c includes the one question keyword of “automatic installment savings plan.” The question keyword 183c includes the one question keyword of “installment investment plan.” For example, the selector 14 determines that “automatic installment savings plan” and “installment investment plan” are paraphrases of “carefree installment savings plan” and selects the question-answer pairs including these question keywords.

Based on the selected question-answer pairs 182 and 183 and the question keywords 182c and 183c, the generator 15 generates a sentence 181b of “Your question is, ‘carefree installment savings plan (unfamiliarity: 0.33).’ There are two answer candidates.” The emphasizer 16 assigns flags to the response for emphasizing and displaying the question keywords “automatic installment savings plan” and “installment investment plan” corresponding to the query keyword determined to be an unknown word.

The determiner 17 determines a value indicating the unfamiliarity of “carefree installment savings plan.” “Carefree installment savings plan” includes the three words of “carefree,” “installment,” and “savings plan.” “Automatic installment savings plan” includes the three words of “automatic,” “installment,” and “savings plan.” “Installment investment plan” includes the three words of “installment,” “investment,” and “plan.” The determiner 17 counts the number of words matching between the query keyword and each question keyword. In the example, the number of words matching between the query keyword and each question keyword is 2. For example, the determiner 17 determines 1−2/3=1/3 (0.33) as the value indicating the unfamiliarity. The determiner 17 determines 1−1/3=2/3 (0.67) as the similarity between the query keyword and each question keyword. The emphasizer 16 emphasizes the question keywords according to these values.

As an example, based on the query sentence, the first query keyword of which the value indicating the unfamiliarity is a first value and a second query keyword of which the value indicating the unfamiliarity is a second value are set. The emphasizer 16 assigns flags to the response so that the form of the display of the first query keyword is different from the form of the display of the second query keyword in the response.

Instead of using a thesaurus when determining the unfamiliarity, the determiner 17 may use a model calculating the unfamiliarity based on the query sentence and the query keyword. The determiner 17 may use a neural network model, a support vector machine, a regression model, or the like pre-trained to discriminate between an unknown word and a question keyword included in the question-answer table.

For example, the value indicating the unfamiliarity is assigned to the response by the emphasizer 16 and displayed inside the sentence 181b. Similarities may be displayed for the question keywords 182c and 183c based on the words matching each query keyword and the number of matching words.

In the example of FIG. 13, based on the response including the sentence 181b, the user corrects the query keyword and inputs a query sentence 181c of “For an automatic installment savings plan” to the display control system 2a. Based on the query sentence 181c, the processor 10 narrows down the previously-selected question-answer pairs 182 and 183 to the question-answer pair 182. Based on the narrowing down, the processor 10 confirms whether or not the question 182a is appropriate for the inquiry of the user by outputting a sentence 181d of “Your question is, ‘Tell me how to apply for an automatic installment savings plan.’ An automatic installment savings plan is . . . .”

### Third Embodiment

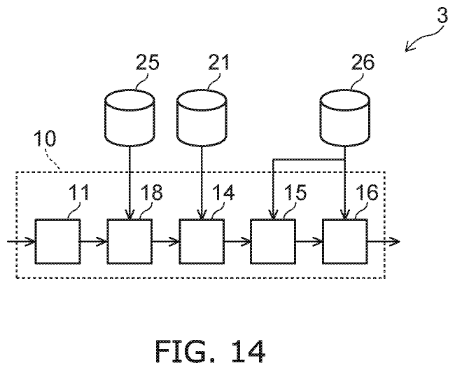

FIG. 14 is a schematic view illustrating a display control system according to a third embodiment.

In the display control system 3 according to the third embodiment, the processor 10 generates a response by referring to a fifth memory 25 and a sixth memory 26. The fifth memory 25 stores rules or a model used to understand intention. The sixth memory 26 stores a conceptual dictionary. The fifth memory 25 and the sixth memory 26 each include a memory device. The memory device includes, for example, at least one of a HDD, NAS, an eMMC, a SSD, or a SSHD. One memory device may function as the first memory 21, the fifth memory 25, and the sixth memory 26.

The conceptual dictionary includes multiple attribute data. Each attribute data includes an attribute indicating a characteristic of the question-answer pair, and an attribute value indicating the specific content of the attribute. For example, the two sets of attribute data of the attribute value of “education loan” for the attribute of “service name” and the attribute value of “I'd like to know the interest rate” for the attribute of “user action” are assigned to the question-answer pair 110a of the question-answer table shown in FIG. 2. The two sets of attribute data of the attribute value of “education loan” for the attribute of “service name” and the attribute value of “I'd like to know the borrowing period” for the attribute of “user action” are assigned to the question-answer pair 110b. Similarly, an attribute and an attribute value corresponding to the question are assigned to the other question-answer pairs.

Each rule includes a condition, and a result when the condition is satisfied. The result includes the attribute, and the attribute value relating to the attribute. For example, when the query sentence satisfies a condition, as a result, it is determined that the query sentence mentions the attribute and the attribute value recited.

As an example, the rule is set to “The service name is ‘education loan’ if ‘education loan’ or ‘tuition loan’ is included in the query sentence. When “education loan” or “tuition loan” is included in the query sentence, an intention understander 18 determines that the query sentence mentions the attribute value of “education loan” included in the attribute of “service name.”

As another example, the rule is set to “The user action is ‘I'd like to know the interest rate’ if ‘I'd like to know the interest rate,’ ‘Tell me the interest rate,’ or ‘How much is the interest rate’ are included in the query sentence. When “I'd like to know the interest rate,” “Tell me the interest rate,” or “How much is the interest rate” are included in the query sentence, the intention understander 18 determines that the query sentence mentions the attribute value of “I'd like to know the interest rate” included in the attribute of “user action.”

As shown in FIG. 14, the processor 10 includes the acceptor 11, the intention understander 18, the selector 14, the generator 15, and the emphasizer 16.

When the acceptor 11 accepts the input of the query sentence, the intention understander 18 understands or estimates the intention of the query sentence by referring to the rules or the model stored in the fifth memory 25. Or, the fifth memory 25 may store an artificial neural network model or a recurrent neural network model. These neural network models are pre-trained using training data. The training data includes multiple data pairs including a sentence and the intention indicated by the sentence. The intention understander 18 understands the intention of the query sentence by using the artificial neural network model or the recurrent neural network model.

The selector 14 selects the question-answer pairs associated with the intention of the query sentence from the question-answer table. The generator 15 generates the response based on the selected question-answer pairs and the attributes and the attribute values assigned to the question-answer pairs while referring to the conceptual dictionary of the sixth memory 26. The emphasizer 16 determines whether or not the attribute and the attribute value are included in the generated response while referring to the conceptual dictionary of the sixth memory 26. When the attribute and the attribute value are included in the generated response, the emphasizer 16 assigns a flag to the response for emphasizing at least one of the attribute or the attribute value.

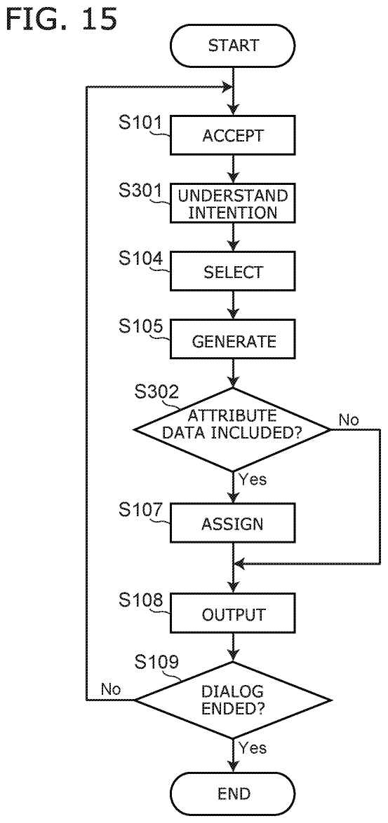

FIG. 15 is a flowchart illustrating the processing of the display control system according to the third embodiment.

The acceptor 11 accepts the query sentence input by the user (step S101). The intention understander 18 understands the intention of the query sentence (step S301). Based on the result of the intention understanding, the selector 14 selects one or more question-answer pairs (step S104). The generator 15 generates a response based on the selected question-answer pairs (step S105). The emphasizer 16 determines whether or not attribute data is included in the response (step S302). When attribute data is included, the emphasizer 16 assigns a flag to the response for emphasizing the attribute data (step S107). The emphasizer 16 outputs the response to an external device (step S108). The processor 10 determines whether or not the dialog has ended (step S109).

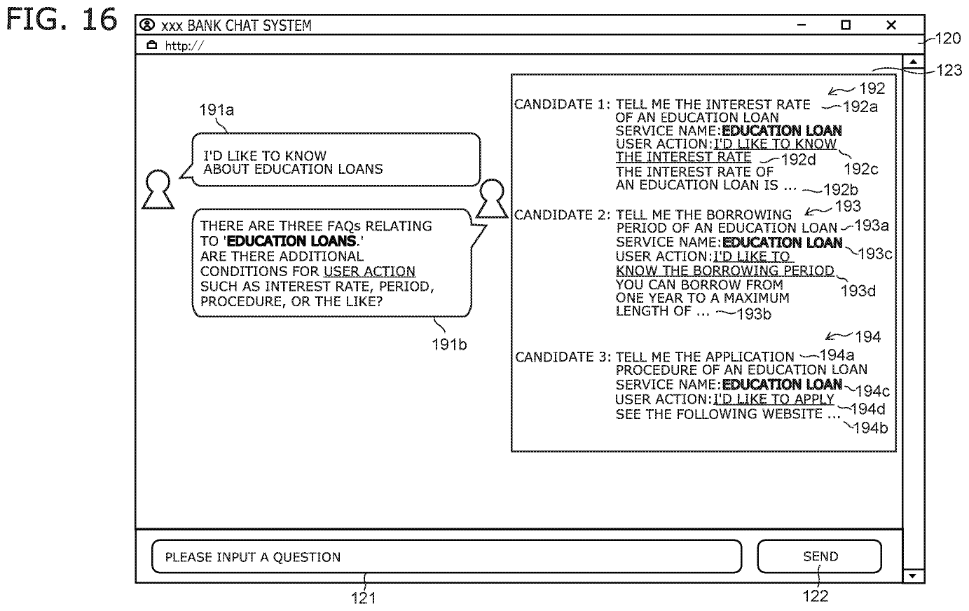

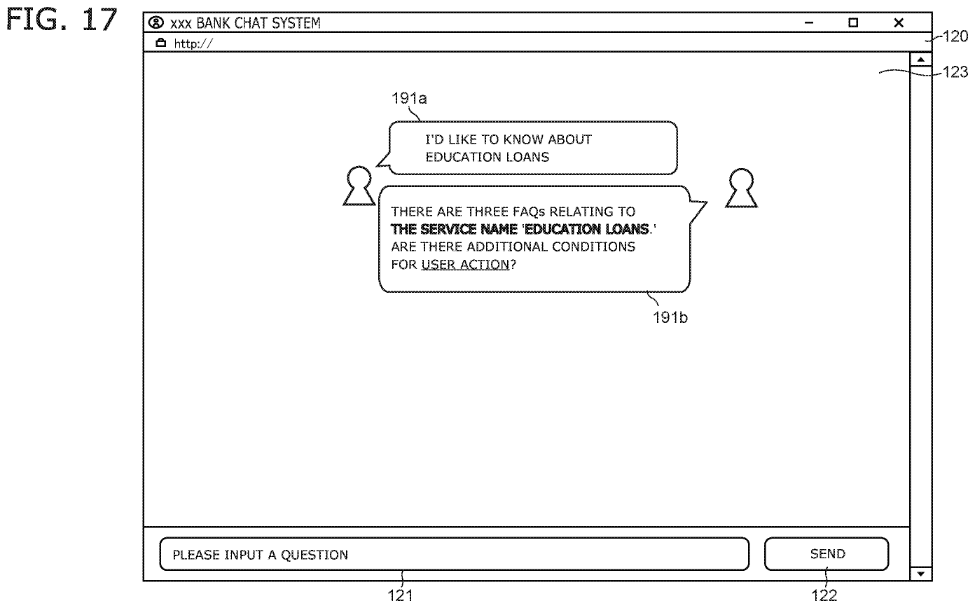

FIG. 16 and FIG. 17 are schematic views illustrating outputs of the display control system according to the third embodiment.

FIG. 16 and FIG. 17 illustrate the operation when the processor 10 responds based on the question-answer table of a bank.

In the example of FIG. 16, the user inputs a query sentence 191a of “I'd like to know about education loans” to the display control system 3. The intention understander 18 understands the intention of the query sentence 191a according to the rules. For example, as a result of the intention understanding, the intention understander 18 determines that the query sentence 191a mentions “education loan” included in the attribute of “service name.”

The selector 14 refers to the question-answer table and selects the question-answer pairs to which the attribute of “service name” is assigned, and “education loan” is assigned as the attribute value of the attribute. Question-answer pairs 192 to 194 are selected in the example of FIG. 16. The question-answer pairs 192 to 194 respectively include questions 192a to 194a and answers 192b to 194b.

Attribute data 192c in which the attribute is “service name” and the attribute value is “education loan” and attribute data 192d in which the attribute is “user action” and the attribute value is “I'd like to know the interest rate” are assigned to the question-answer pair 192. Attribute data 193c in which the attribute is “service name” and the attribute value is “education loan” and attribute data 193d in which the attribute is “user action” and the attribute value is “I'd like to know the borrowing period” are assigned to the question-answer pair 193. Attribute data 194c in which the attribute is “service name” and the attribute value is “education loan” and attribute data 194d in which the attribute is “user action” and the attribute value is “I'd like to apply” are assigned to the question-answer pair 194. Because three question-answer pairs are selected, the generator 15 generates a sentence 191b for narrowing down the question-answer pairs.

The emphasizer 16 assigns flags for emphasizing and displaying the attribute and the attribute value mentioned in the query sentence and the attribute and the attribute value included in the sentence generated by the generator 15. In the example of FIG. 16, the attribute data 192c to 194c in which the attribute is “service name” and the attribute value is “education loan” match the attribute and the attribute value mentioned by the query sentence 191a. Accordingly, the attribute data 192c to 194c are displayed as being emphasized. Also, the attribute of “user action” is mentioned in the sentence 191b. The emphasizer 16 emphasizes the attribute values included in this attribute. The attribute data 192d to 194d are displayed as being emphasized thereby.

In the example of FIG. 16, all of the attributes and the attribute values are displayed as being emphasized. Thereby, compared to the case where a conceptual dictionary is not used, how the display control system 3 understood the query sentence can be understood more easily from the display. Also, by emphasizing the attributes and the attribute values included in the sentence output from the display control system 3, the user easily can ascertain or estimate what kind of query sentence to input to the display control system to easily obtain the sought question-answer pair.

In the example of FIG. 17, similarly to the example of FIG. 16, the user inputs the query sentence 191a of “I'd like to know about education loans” to the display control system 3. In the example, only the sentence 191b is output because the response is output concisely. In the sentence 191b, the attribute and the attribute value mentioned in the query sentence and only a part of the attributes and the attribute values not mentioned in the query sentence are emphasized.

The case is described above where the response output from the system according to the embodiment is displayed in a monitor. The response that is output from the system according to the embodiment may be output as a voice. An audio control system according to the embodiment includes the processor 10.

Instead of displaying the response to the query sentence of the user, the processor 10 may provide an audio output to an audio output device (a speaker). When accepting the first sentence input by the user, the processor 10 provides audio output of the first question-answer pair including the first question including the query keyword included in the first sentence, and the first answer to the first question. Also, the processor 10 provides audio output of the second sentence including a question keyword included in the first question and different from the query keyword. In these audio outputs, the processor 10 outputs the words other than the query keyword and the question keyword in the first form. The processor 10 outputs the query keyword in the second form different from the first form. The processor 10 outputs the question keyword in the third form different from the first form and the second form.

For example, in the audio output, the processor 10 performs at least one of providing a pause before and after the query keyword and before and after the question keyword, reducing the reading speed of the query keyword and the question keyword, increasing the reading sound level of the query keyword and the question keyword, or providing an accent to the query keyword and the question keyword.

It is desirable for the form of the audio output of the query keyword to be different from the audio output of the display of the question keyword. For example, when providing the audio output of the query keyword, the processor 10 performs one of providing a pause before and after the keyword, reducing the reading speed of the keyword, increasing the reading sound level of the keyword, or providing an accent to the keyword. For example, when providing the audio output of the question keyword, the processor 10 performs another one of providing a pause before and after the keyword, reducing the reading speed of the keyword, increasing the reading sound level of the keyword, or providing an accent to the keyword.

In the case where the response is provided by audio output from a speaker, the flags by the emphasizer 16 include, for example, information for performing at least one of providing a pause before and after the query keyword and before and after the question keyword, reducing the reading speed of the query keyword and the question keyword, increasing the reading sound level of the query keyword and the question keyword, or providing an accent to the query keyword and the question keyword.

In the case of providing an audio output of the response, the time necessary to read aloud the response lengthens if the response includes a question-answer pair. Therefore, in the case where the response is output by a voice, for example, as shown in FIG. 17, the output of the question-answer pair may be omitted; and only a sentence may be output. The generator 15 includes, in the sentence, the attribute and the attribute value mentioned in the query sentence and attributes and attribute values not mentioned in the query sentence. By outputting a response including only a sentence in which a part of the keywords is emphasized, the display control system 3 can convey to the user how the query sentence was understood; and the time necessary for the user to confirm the response can be short.

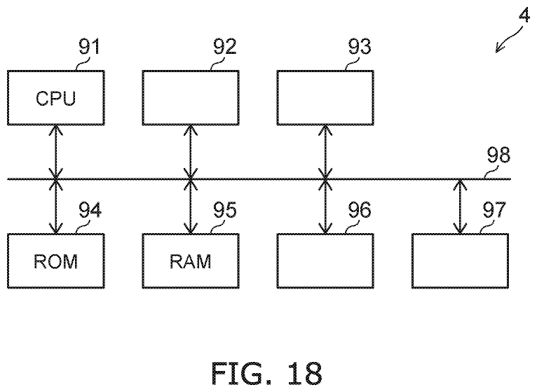

FIG. 18 is a schematic view illustrating the configuration of a dialog device according to the embodiment.

For example, the systems according to the embodiments described above are realized using the dialog device 4 shown in FIG. 18. As an example, the dialog device 4 is realized using a hardware configuration similar to a general computer (information processing device). The dialog device 4 includes a CPU (Central Processing Unit) 91, an inputter 92, an outputter 93, ROM (Read Only Memory) 94, RAM (Random Access Memory) 95, memory 96, a communication device 97, and a bus 98. The components are connected by the bus 98.

The CPU 91 performs various processing in cooperation with various programs pre-stored in the ROM 94 or the memory 96 and comprehensively controls the operations of the components included in the dialog device 4. In the processing, the CPU 91 uses a prescribed region of the RAM 95 as a work region. The CPU 91 realizes the inputter 92, the outputter 93, the communication device 97, etc., in cooperation with programs pre-stored in the ROM 94 or the memory 96.

The inputter 92 includes, for example, at least one of a keyboard, a microphone, or a touch panel. The inputter 92 accepts the information input from the user as an instruction signal and outputs the instruction signal to the CPU 91. The outputter 93 includes, for example, at least one of a monitor, a speaker, or a printer. The outputter 93 outputs various information based on the signals output from the CPU 91.

The ROM 94 non-rewritably stores programs used to control the dialog device 4, various setting information, etc. The RAM 95 is a volatile storage medium such as SDRAM (Synchronous Dynamic Random Access Memory), etc. The RAM 95 functions as a work region of the CPU 91. Specifically, the RAM 95 functions as a buffer that temporarily stores various variables, parameters, etc., used by the dialog device 4, etc.

The memory 96 is a rewritable recording device such as a storage medium using a semiconductor such as flash memory or the like, a magnetically or an optically recordable storage medium, etc. The memory 96 stores programs used to control the dialog device 4, various setting information, etc. The memory 96 functions as the first to sixth memories 21 to 26. The communication device 97 is used to transmit and receive information by communicating with external devices.

According to the embodiments described above, a display control system, a program, and a storage medium can be provided in which the user easily can ascertain or estimate what kind of query sentence to input to the display control system to easily obtain the sought question-answer pair.

For example, the processing of the various data recited above is performed based on a program (software). For example, the processing of the various information recited above is performed by a computer storing the program and reading the program.

The processing of the various information recited above may be recorded in a magnetic disk (a flexible disk, a hard disk, etc.), an optical disk (CD-ROM, CD-R, CD-RW, DVD-ROM, DVD±R, DVD±RW, etc.), semiconductor memory, or another recording medium as a program that can be executed by a computer.

For example, the information that is recorded in the recording medium can be read by a computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

At least a part of the processing of the information recited above may be performed by various software operating on a computer (or an embedded system) based on a program installed in the computer from a recording medium. The software includes, for example, an OS (operating system), etc. The software may include, for example, middleware operating on a network, etc.

The recording medium according to the embodiments stores a program that can cause a computer to execute the processing of the various information recited above. The recording medium according to the embodiments also includes a recording medium to which a program is downloaded and stored using a LAN, the Internet, etc. The processing recited above may be performed based on multiple recording media.

The computer according to the embodiments includes one or multiple devices (e.g., personal computers, etc.). The computer according to the embodiments may include multiple devices connected by a network.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in display control systems such as processors, storage mediums, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all display control systems and storage media practicable by an appropriate design modification by one skilled in the art based on the display control systems and the storage media described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display control system, comprising a processor,
the processor being capable of displaying a second sentence and at least a part of a first question-answer pair when accepting a first sentence including a first query keyword, the first sentence being input by a user, the first question-answer pair including a first question and a first answer to the first question, the first question including the first query keyword, the second sentence including a first question keyword included in the first question, the processor being capable of displaying a word other than the first query keyword and the first question keyword in a first form, the first query keyword in a second form different from the first form, and the first question keyword in a third form different from the first form and the second form.

2. The system according to claim 1, wherein
the first question further includes a second question keyword different from the first query keyword and the first question keyword,
the second sentence does not include the second question keyword, and
the processor is capable of displaying the second question keyword in the first form.

3. The system according to claim 1, wherein
the first question further includes a second question keyword different from the first query keyword and the first question keyword,
the second sentence includes the second question keyword, and
the processor is capable of displaying the second question keyword in a fourth form different from the first form, the second form, and the third form.

4. The system according to claim 3, wherein
the processor selects the first question-answer pair from a question-answer table including a plurality of question-answer pairs, each question-answer pair including a question and an answer to the question, and
in the question-answer table, a number of the questions including the first question keyword is different from a number of the questions including the second question keyword.

5. The system according to claim 1, wherein
the second sentence further includes a third question keyword, and
the processor is capable of displaying at least a part of a second question-answer pair, the second question-answer pair including a second question and a second answer to the second question, the second question including the first query keyword and the third question keyword, the processor being capable of displaying a word other than the first query keyword, the first question keyword, and the third question keyword in the first form and capable of displaying the first question keyword and the third question keyword in the third form.

6. The system according to claim 5, wherein
when a third sentence including one of the first question keyword or the third question keyword is input by a user after the processor displays the at least a part of the first question-answer pair, the at least a part of the second question-answer pair, and the second sentence, the processor displays at least a part of one of the first question-answer pair or the second question-answer pair including the one of the first question keyword or the third question keyword.

7. A display control system comprising a processor,
the processor being capable of displaying a second sentence and at least a part of a first question-answer pair when accepting a first sentence including a first query keyword, the first sentence being input by a user, the first question-answer pair including a first question and a first answer to the first question, the first question including a first similar keyword similar to the first query keyword, the second sentence including a first question keyword included in the first question, the processor being capable of displaying a word other than the first similar keyword and the first question keyword in a first form, the first similar keyword in a second form different from the first form, and the first question keyword in a third form different from the first form and the second form.

8. The system according to claim 7, wherein the processor is capable of displaying information indicating a similarity between the first query keyword and the first similar keyword.

9. A storage medium storing a program,
the program causing a processor to
accept a first sentence including a first query keyword, the first sentence being input by a user, and
display a second sentence and at least a part of a first question-answer pair, the first question-answer pair including a first question and a first answer to the first question, the first question including the first query keyword, the second sentence including a first question keyword included in the first question, a word other than the first query keyword and the first question keyword being displayed in a first form, the first query keyword being displayed in a second form different from the first form, the first question keyword being displayed in a third form different from the first form and the second form.
